(19) United States
(12) Patent Application Publication
(10) Pub. No.: US 2016/0278411 A1
(43) Pub. Date: Sep. 29, 2016

(54) MINIMAL DIET CHANGE TO MEET NUTRITIONAL GOALS

(71) Applicant: Xerox Corporation, NORWALK, CT (US)

(72) Inventors: Elizabeth D. Wayman, Ontario, NY (US); Sriganesh Madhvanath, Pittsford, NY (US)

(21) Appl. No.: 14/671,607

(22) Filed: Mar. 27, 2015

(51) Int. Cl. A23L 1/29

(52) U.S. Cl. CPC A23L 1/293

(57) ABSTRACT

A computerized food purchase history system automatically determines a current food diet (e.g., based on an automatically maintained food purchase history). The computerized device automatically compares the current food diet with nutritional goals, to identify nutritional differences, and analyzes the nutritional differences, to identify potential changes to the current food diet using said computerized device. The process of analyzing nutritional differences ranks the potential changes based on a previously established measure of emotional resistance to dietary change. The potential change ranked as having the lowest nutritional differences within a calorie limit and an emotional resistance limit is selected as a recommended change to the current food diet. The computerized device then automatically outputs the recommended change to the current food diet from the computerized device.

### BACKGROUND

Systems and methods herein generally relate to automated food diet systems, and more particularly, to systems and methods that make a minimal diet change to meet nutritional goals.

Obesity is a health problem that is assuming epidemic proportions not only in the US but also in large parts of the world, and is a direct result of poor choice of foods. There are an abundance of diet plans claiming to produce quick and lasting results. Most emphasize weight loss and give only general guidelines for nutrition. They are not personalized in any manner. A personalized diet plan requires the services of a dietician, who may not be accessible or affordable to most individuals and families.

Additionally, healthcare reform includes incentives for wellness. There are many websites and apps promoting wellness. An important aspect of wellness is a healthy diet. There have been several attempts by both government and non-government agencies working in public health to specify guidelines for an “ideal diet” and communicate it in simple terms to the general public. One example is the “food pyramid” which specifies the number of recommended servings of different “food groups” such as grains and vegetables. Another example is the Recommended Daily Intake (RDIs) established by the Food and Nutrition Board of the National Academy of Sciences.

There are also many websites on nutritional scoring of foods. Some of these sites explain relative nutritional values of foods. Some include interactive ways for users to better understand the nutritional value of foods they consume. Some are tailored to special dietary needs, such as cholesterol, or food allergies or intolerances. These can be tedious and time consuming to use since the user must either select foods of interest or enter personal information. Also, there are a variety of different scoring methods producing sometimes conflicting scores for particular foods.

These websites and tools in general are not very helpful since they do not convey to the user the changes they must make to their current diet. Accurate information about their current diet has been difficult to obtain, even for the users themselves, without some form of tedious and meticulous manual recording and self-reporting.

### SUMMARY

Various methods herein automatically determine a current food diet (for an individual or group of people) based on an automatically maintained food purchase history (e.g., using a computerized food purchase history system, such as a point-of-sale tracking system, an industrial food purchasing system, etc.). The methods herein automatically transmit the current food diet from the computerized food purchase history system to a computerized device (e.g., the user's device) that is operatively (meaning directly or indirectly) connected to the food purchase history system (e.g., through a computerized network). The methods herein can optionally automatically output the current food diet to users on a graphic user interface of the computerized device, and provide an option to confirm and/or edit the current food diet on the graphic user interface to eliminate any inaccuracies the automated computerized food purchase history system may inject.

The methods herein automatically compare the current food diet with nutritional goals to identify nutritional differences (e.g., a “nutritional distance”) between the two (using the computerized device). The methods herein automatically analyze such nutritional differences to identify potential changes to the current food diet using the computerized device. The process of analyzing the nutritional differences ranks such potential changes to the current diet based on a previously established measure of emotional resistance to dietary change. This previously established measure of “emotional resistance” to dietary change is based on the magnitude of the change (since extensive changes to the diet would lead to greater emotional resistance than minor changes), and may include additional factors such as historical preferences of a single individual or a group of individuals that is obtained from empirical testing, social research, modeling, etc. Additionally, the potential changes to the current food diet can include introducing a new food item, removing an existing food item, or increasing or decreasing the current consumption of existing food items, etc.

These methods also automatically select one of the potential changes that is ranked as having the lowest nutritional differences within a calorie limit and an emotional resistance limit as the recommended change to the current food diet (e.g., again using the computerized device). Then, the methods herein automatically output to the user the recommended change to the current food diet on the graphic user interface of the computerized device.

Exemplary systems herein include (among other components) a computerized food purchase history system that automatically determines a current food diet (e.g., based on an automatically maintained food purchase history). For example, the computerized food purchase history system can be a point-of-sale tracking system, an industrial food purchasing system, etc.

A computerized device is operatively connected to the computerized food purchase history system over a computerized network. The computerized device automatically compares the current food diet with nutritional goals to identify nutritional differences, and analyzes the nutritional differences, to identify potential changes to the current food diet. The process of analyzing the nutritional differences ranks the potential changes based on a previously established measure of emotional resistance to dietary change. Again, the potential changes to the current food diet can include introducing a new food item to the set, removing an existing food item, or increasing or decreasing the current consumption of existing food items, etc.

The computerized device then automatically selects one of the potential changes ranked as having the lowest nutritional differences within a calorie limit and an emotional resistance limit as a recommended change to the current food diet. Again, the previously established measure of emotional resistance to dietary change can be based, for example, on the magnitude of change, as well as historical preferences of a single individual or a group of individuals. The computerized device then automatically outputs the recommended change to the current food diet from the computerized device.

These and other features are described in, or are apparent from, the following detailed description.

### BRIEF DESCRIPTION OF THE DRAWINGS

Various exemplary systems and methods are described in detail below, with reference to the attached drawing figures, in which:

FIG. 1 is a schematic diagram illustrating a matrix used herein;

FIG. 2 is a flow diagram of various methods herein;

FIG. 3 is a schematic diagram illustrating systems herein; and

FIG. 4 is a schematic diagram illustrating devices herein.

### DETAILED DESCRIPTION

As mentioned above, while there are an abundance of diet plans claiming to produce quick and lasting results, most emphasize weight loss and give only general guidelines for nutrition, and such are not personalized in any manner. Therefore, the systems and methods herein provide systems and methods that compute the minimal change to a current diet to meet a specific nutritional goal, such as the Recommended Dietary Intake (RDI) established by the Food and Nutrition Board of the National Academy of Sciences. The minimal change is in terms of more specific changes such as increasing/decreasing the current consumption of a food item, introducing a new food item into the diet, and discontinuing consumption of a food item, and is “minimal” in the sense of minimizing the user's emotional resistance to the change. The systems and methods herein also allow the specification of various constraints (e.g., budget (the net budgetary impact of the change) should be nil, or bounded by some number).

This systems and methods herein may be applied in multiple ways. For example, systems and methods herein may be used to provide users with a single list of dietary changes that they should make in order to achieve their goal (which is a different user experience from incremental recommendations). Instead of individual users, the systems and methods herein may be applied to a school board, SNAP program board, or other organization responsible for making good choices on behalf of a user population. The systems and methods herein may also be used to drive more incremental recommendations, by setting up intermediate nutritional goals that lie in between the user's current state of nutrition and the final nutritional goal.

Grocery stores now maintain data on customer purchases through, for example, “shoppers club” accounts. This data includes all the purchases a customer makes at each shopping event. This data may be used to create a more accurate picture of a user's diet. However for the end user, (which may an individual or an institution such as a school board), it is still not clear what changes should be made to the current diet in order to achieve one's nutritional goals. The systems and methods herein leverage current diet data (for example, from grocery receipts), nutrition data and nutritional goal data to compute the minimal change to the current diet, tailored to the particular shopper's situation, which may be described in the form of various constraints. The motivation for minimizing the change to the diet is to make it easier for the user to adopt the changes and not be overwhelmed by the magnitude of the change.

Some examples herein describe an individual's diet, however, those ordinarily skilled in the art would understand that the systems and methods herein are equally extendable to groups, such as family unit or school board.

For the purposes of this disclosure, the recommended monthly intake of various nutrients is represented as a vector R in a n-dimensional space, where n represents the number of nutrition dimensions. For example, the nutrition dimensions for the vector R correspond to “Total Fat”, “Saturated Fatty Acids”, . . . “Protein”, . . . “Vitamin A”, . . . , “Chloride”. Note that each dimension may have its own unit, e.g., “mg”, “μg”, “IU”, etc. The above values would be different for an individual with a different recommended Caloric Intake, dietary restrictions, health conditions, and so on.

With regard to estimating the current diet, the methods and systems herein define current diet D₀ as a set comprised of ordered pairs (fᵢ, cᵢ) where fᵢ is a food item “currently consumed” by the user, and cᵢ is the average current monthly consumption of the food item by the user. Food items here refers to all food products (which the methods and systems herein designate by set F) stocked at the typical grocery store, which may be branded (e.g. Kellogg's® corn flakes, Wegman's® organic apples) or unbranded (carrots), and may be sold as units or by weight.

By considering food purchases over a reasonably long time period (e.g. six months) the methods and systems herein can determine the food items that are currently consumed as well as estimate “average monthly consumption” of each such food item, measured in servings. For example, if the methods and systems herein see that the user bought 5 lbs of bananas over 3 months, the methods and systems herein can estimate the monthly consumption of bananas as 5/3=1.33 lbs=5.11 servings (given that one serving of bananas is a “medium banana” with weight 225 gms). For packaged foods sold in units, the methods and systems herein convert the number of units bought (e.g. 2 units of Kellogg's® corn flakes 300 g pack) to serving units using knowledge of the number of servings in each unit, which is typically available in the product description. Thus the cᵢs are always expressed in servings of the corresponding food items.

The methods and systems herein can improve upon the above estimate in various ways, e.g., by taking into account the exact duration between repeat purchases of a food item (e.g. a user may buy a large bag of rice once in six months, but bananas each week). The consumption, cᵢ, could alternatively be measured at a different interval, such as weekly, or daily. Monthly allows consideration of a larger variety of foods.

With respect to estimating current nutritional intake for each food item fᵢ in the current diet D₀, the methods and systems herein estimate the food item's nutritional content using a nutrition database, several of which are available, both proprietary and in the public domain. For example, some databases provide information about the nutritional content of a food item given its UPC. Public databases provide nutrition information for thousands of common foods, from carrots to cheesecake. In addition, many grocery stores themselves provide this information on their websites for the food items they carry.

In this step the methods and systems herein compute the current monthly nutritional intake by looking up the nutritional content of each food item fᵢ using one or more databases, and aggregating them across all the food items in the current diet D₀, scaled by the average monthly consumption cᵢ of each food item. The methods and systems herein represent this computation as a function g(D) which takes a given diet D as input, and returns the corresponding nutritional intake as another point S in the n-dimensional nutrition space that also contains R, the recommended monthly nutritional intake.

With respect to computing the minimal change to the diet, in this step, the methods and systems herein estimate the minimal change in current diet D₀ that causes the corresponding monthly nutritional intake S to move as close as possible to the recommended monthly nutritional intake R. The “minimal change” may be thought of the smallest set of changes made to current diet D₀ to create a new diet D₁, where a change may be introducing a new food item to the set, removing an existing food item, or increasing or decreasing the current consumption (cᵢs) of existing food items in D₀. In a more general formulation, cost values may be associated with each type of change, and the “minimal change” would correspond to the overall change to D₀ with the lowest cost. This is non-trivial since any change in the current diet (e.g. introducing a new food item) impacts multiple nutrients.

There are several approaches to solving this problem, and the following example uses dynamic programming; however, those skilled in the art would understand that the methods and systems herein can equally use other approaches.

One known concept from combinatorial optimization is the knapsack problem. Given items of different values and volumes, the solution to the knapsack problem finds the most valuable set of items that fit in a knapsack of fixed volume. The term knapsack problem invokes the image of the backpacker who is constrained by a fixed-size knapsack and so must fill it only with the most useful items. The knapsack problem is hard because each item must be put entirely in the knapsack or not included at all, for a simple greedy method finds the optimal selection whenever it is allowed to subdivide objects arbitrarily.

One exemplary formulation is the 0/1 knapsack problem, where there is only one of each kind of item. The bounded knapsack problem removes the restriction that there is only one of each item, but restricts the number of copies of each kind of item to an integer value. The unbounded knapsack problem places no upper bound on the number of copies of each kind of item except that it be a non-negative integer.

Thus, in one example, the methods and systems herein can model this as an unbounded knapsack problem where the knapsack represents the diet, and the capacity of the knapsack is the recommended monthly caloric intake (e.g. the US Recommended Daily Intake values are given for a 2000 calorie diet, for an average adult). The caloric intake for an individual varies depending on weight, activity level and gender.

Intuitively, the objective is to fill the knapsack with different servings of available food items such that the total “nutritional value” of the knapsack is maximized, subject to the constraint that the net calories from the selected items does not exceed the recommended caloric intake. But in doing so, the methods and systems herein make the least possible change to the current diet.

Thus, the methods and systems herein use notable differences from the traditional unbounded knapsack problem. First, unlike the traditional problem, the “value” of an individual item is not meaningful in isolation. Instead, the methods and systems herein seek to understand the extent to which the current diet as a whole (the knapsack contents) meets the recommended intake of nutrients. Therefore, the methods and systems herein maximize the nutritional value of the knapsack as a whole. In order to do that, the methods and systems herein actually minimize the difference between its nutritional content and the recommended intake. Secondly, unlike the traditional knapsack problem, when selecting items to add to the knapsack, the methods and systems herein simultaneously minimize the change to the original diet.

The methods and systems herein address these differences as follows. First, instead of using a constant value for the nutritional value of a given food item, the methods and systems herein use the value output by a function to assess the impact of adding a serving of item fᵢ to a diet D. The function is

nutr_dist_add(i,D)=|R−Σ_{k:f}_{ₖ}_{in D}(Nₖ*cₖ)+Nᵢ|

which represents the distance from optimal nutritional intake R obtained by adding one serving of food fᵢ to diet D. Here Nᵢ represents the nutrition provided by one serving of food fᵢ represented as a vector in the n-dimensional nutrition space.

While the methods and systems herein consider what foods to add to the knapsack (diet) as in the traditional knapsack problem, the methods and systems herein also consider the diet change distance d, to the original diet D₀. This may be thought of as the “emotional resistance or cost” to the user of making the dietary change. It is computed by the function diet_dist_add (i, D), which returns the “cost” of adding one serving of food fᵢ to diet D. Diet change distance may be defined in various ways. For example, a simple formulation may be the number of new food items introduced into the diet, i.e. food items in D that are not in D₀. Alternatively, the “edit distance” between the original and proposed diets may be computed by assigning costs to adding, removing, or replacing a serving of a food item. These costs could be modeled as simple constants, or could in a more sophisticated model, take into account “taste” differences or include other personal and interpersonal factors for emotional resistance to adoption, such as peer adoption and social acceptance. Thus, this distance captures (in essence) the user's resistance to dietary change, and is different than a measure of nutrition.

For convenience, the following notation is used:

F=Set of m food items f₁, . . . , fₘ (available from a typical grocery store)

D=Diet, modeled as the set {(fᵢ, c₁)}, where fᵢ is a food item from F and cᵢ is its current monthly consumption, measured in servings.

D₀=Initial diet

Nᵢ=nutrition provided by one serving of food fᵢ, represented as a n-dimensional vector, where n is the number of nutrients being measured.

wᵢ=calories provided by one serving of food fᵢ,

R=Recommended monthly intake of nutrients represented as a n-dimensional vector, where n, again, is the number of nutrients being measured.

W=Target calorie intake for a month.

W₀=Monthly Calorie intake corresponding to initial diet D₀.

dₘₐₓ=constant indicating the maximum (emotional resistance to) dietary change that can be accommodated. Finding dₘₐₓ requires experimentation and depends upon how diet change distance is defined, as well as the starting diet, as previously described. For example, in the simple case where dietary change is modeled as the number of new foods introduced into the diet, dₘₐₓ=m.

Thus, in one example, the methods and systems herein maintain two 2-dimensional arrays, M[w, d] and D[w, d]. In one 2-dimensional array, the array element M[w, d] is equal to the minimum nutritional distance between the current diet D₀ and the recommended intake R, for calorie intake at most w (the knapsack capacity), and diet change distance at most d from the original diet D₀. In another 2-dimensional array, the array element D[w, d] is equal to the contents of the diet corresponding to M[w, d], expressed as a set, D, described above.

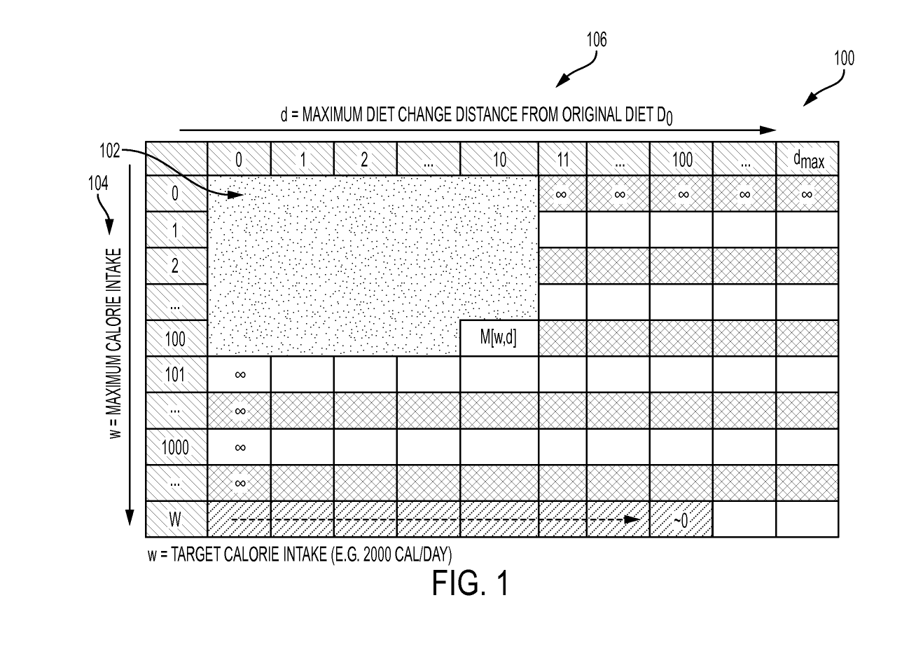

One example of the array M[w, d] is shown as item 100 in FIG. 1. Item 102 is the section of matrix used to compute M[w,d] as shown below. Generally, the methods and systems herein identify the diet change that has the lowest nutritional difference value (lowest value in area 102 of the matrix 100) within a previously established calorie limit 104 (e.g., 100 calories) and a previously established diet change limit 106 (e.g., an diet change value of 10).

Written using notation, the initialization sets:

M[0, *]=infinity

M[*, 0]=infinity

The iterations are:

for w from 1 to W:

for d from 1 to dₘₐₓ:

$$M [ w , d ] = min {i \text{:} {w}_{i} \leq w}_{{and}_{j \text{:} {d}_{j} \leq d and diet \_ dis t \_ add ( i , D ( w - {w}_{i} , {d}_{j} ) ) \leq d}} nut\_dist \_add ( i , D ( w - {w}_{i} , {d}_{j} ) )$$

This computes the nutritional distance of adding one serving of fᵢ with calories wᵢ to the optimal diet for net calorie intake (w−wᵢ) s.t. the diet change distance is ≦d, and minimizes over all foods with wᵢ≦w. Since the “optimal diet” depends on the diet change distance and the methods and systems herein are not making any assumptions about the nature of this distance, the methods and systems herein would need to consider all optimal diets (w−w₁, dⱼ) where dⱼ<=d.

D[w, d]=D[w−wᵢₘᵢₙ, dⱼₘᵢₙ], incrementing c from the element (fᵢₘᵢₙ, cᵢₘᵢₙ) to reflect the additional serving, where iₘᵢₙ and jₘᵢₙ are the indices which satisfy the above minimization equation.

In one example, consider M[10, 5]. Consider item Fᵢ with wᵢ=3. The traditional approach to the knapsack problem would compare with M[7]+vᵢ with all other Fⱼ, i≠j, where vᵢ represents the change in nutrition from adding food i. To the contrary, the methods and systems herein also compare for all d up to and including the current d.

In the solution, the iterations result in the creation of two 2-dimensional matrices:

$$[ \begin{matrix}{M}_{0 , 0} & … & {M}_{0 , {d}_{max}} \\ ⋮ & ⋱ & ⋮ \\ {M}_{W , 0} & … & {M}_{W , {d}_{max}}\end{matrix} ] [ \begin{matrix}{D}_{0 , 0} & … & {D}_{0 , {d}_{max}} \\ ⋮ & ⋱ & ⋮ \\ {D}_{W , 0} & … & {D}_{W , {d}_{max}}\end{matrix} ]$$

To find the solution, the methods and systems herein choose a row in the m matrix for w=target calories needed for diet. This typically would be the last row w=W. The entries of that row decrease in value (nutritional distance) as they approach the ideal nutrition profile, R, and increase in diet change distance, from left to right. The methods and systems herein choose the element with the best tradeoff of nutrition/diet change distance for the individual. If diet change is not a factor, the methods and systems herein can choose the element whose nutritional distance value is close to 0, indicating ideal nutrition.

As noted above, the dynamic programming approach in only one approach used by methods and systems herein. Other processes that are used by methods and systems herein to obtain the solution can include, for example, constrained gradient descent or genetic processes.

As also noted above, the methods and systems herein can be extended from individual use to use with groups. In one example, the methods and systems herein are useful with a typical family unit of more than one individual, where all the food purchases are made by one person for the household. In another example, the methods and systems herein consider a group situation, such as a school lunch plan. Here one person is responsible for planning a single meal per day for many students.

In the first example of the family unit, when estimating the recommended nutritional intake: the nutrition vector, n, is an aggregate of the nutritional needs of all the family members. When estimating the current diet, since typically one person purchases all the food for the household, the methods and systems herein use the entire grocery receipt for the computation as described above. When estimating current nutritional intake, no changes from the above are necessary. When computing the minimal change to the diet, the methods and systems herein proceed with the computation as described above, using the aggregate nutrition vector. The values for servings, in the initial diet do and the solution diet will represent the aggregate servings for the family.

In the second example of a school lunch plan, when estimating recommended nutritional intake, the nutrition vector, n, represents the nutritional needs of a single average student for the meals served over the course of the month. If only one meal per weekday is served, the nutritional needs would be scaled appropriately. When estimating the current diet, this calculation includes all the purchases made for the lunch plan. When estimating current nutritional intake, again no changes from the above are necessary. When computing the minimal change to the diet, the methods and systems herein proceed with the computation as described above, using the nutrition vector representing the single average student. The values for servings, in the initial diet do and the solution diet represent the servings for the single average student.

Additionally, these methods and systems can incorporate other constraints, such as the computation of the diet change distance in diet_dist_add( ) For example, to include a constraint on budgeting food cost diet_dist_add( ) can incorporate a factor for the cost of the food item. Additionally, dietary restrictions of various kinds can be modeled as high costs associated with specific foods that are not, for example, vegan, organically grown, kosher or gluten-free.

Not all nutrition comes from groceries purchased and food cooked at home; some fraction also comes from eating out in restaurants. Restaurant receipts may be used to augment grocery receipts to build a more complete picture of the user's nutrition.

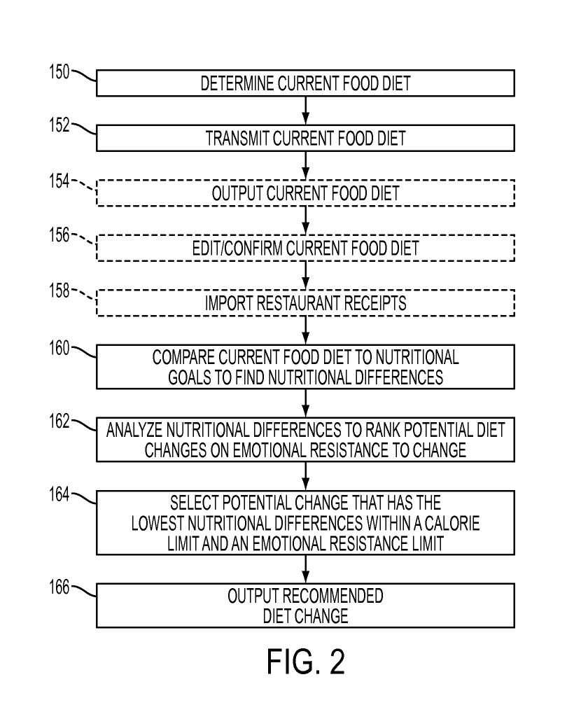

FIG. 2 is flowchart illustrating exemplary methods herein. In item 150, these methods automatically determine a current food diet (for an individual or group of people) based on an automatically maintained food purchase history (e.g., using a computerized food purchase history system, such as a point-of-sale tracking system, an industrial food purchasing system, etc.). As shown in item 152, the methods herein automatically transmit the current food diet from the computerized food purchase history system to a computerized device (e.g., the user's device) that is operatively (meaning directly or indirectly) connected to the food purchase history system (e.g., through a computerized network).

As shown in the dashed box 154, the methods herein can optionally automatically output the current food diet to users on a graphic user interface of the computerized device, and (in dashed box 156) provide an option to confirm and/or edit the current food diet on the graphic user interface to eliminate any inaccuracies the automated computerized food purchase history system may inject. Also, as shown in item 158, the methods herein can optionally allow the user to input or import restaurant receipts (e.g., through manual entry, scanning, obtaining a picture of a restaurant receipt using their smart phone, through communication with automated uploading equipment utilized by restaurants, etc.) to provide additional information of consumption and nutrition; and thereby further edit the automatically calculated current food diet through their own device (user's personal computer, scanner, smart phone, etc.). In item 160, the methods herein automatically compare the current food diet with nutritional goals (which can be one of many) to identify nutritional differences (e.g., using the computerized device). The methods herein automatically analyze such “nutritional differences” to identify potential changes to the current food diet using the computerized device, in item 162. In item 162, the process of analyzing the nutritional differences ranks the potential changes based on how the potential changes decrease the nutritional differences and ranks the potential changes based on a previously established measure of emotional resistance to dietary change. For example, the potential changes to the current food diet in item 162 can include introducing a new food item to the set, removing an existing food item, or increasing or decreasing the current consumption of existing food items, etc. This previously established measure of “emotional resistance” to dietary change in item 162 can be based on the magnitude of the change, historical preferences of a single individual or a group of individuals that is obtained from empirical testing, social research, modeling, etc.

These methods also automatically select one of the potential changes that is ranked as having the lowest nutritional differences within a calorie limit and an emotional resistance limit as the recommended change to the current food diet (e.g., again using the computerized device) in item 164. Then, the methods herein automatically output to the user the recommended change to the current food diet on the graphic user interface of the computerized device in item 166. For example, the recommended change to the current food diet could be automatically output as an automatically modified online shopping list that is edited to include the recommended change.

The hardware described herein plays a significant part in permitting the foregoing method to be performed, rather than function solely as a mechanism for permitting a solution to be achieved more quickly, (i.e., through the utilization of a computer for performing calculations). As would be understood by one ordinarily skilled in the art, the minimization processes described herein cannot be performed by human alone (or one operating with a pen and a pad of paper) and instead such processes can only be performed by a machine. Specifically, processes such as minimization, tracking purchases using point-of-sale devices, storage and electronic transmission of such data over networks, etc., requires the utilization of different specialized machines.

Also, the tracking of the food purchases using point-of-saleve devices, storage of such data, aggregation of such data, transmission such data, etc., is integral with the process performed by the methods herein, and is not mere post-solution activity, because the processing presented in the claims be performed without such electronic transmissions. In other words, these various machines are integral with the methods herein because the methods cannot be performed without the machines (and cannot be performed by humans alone).

Additionally, the methods herein solve many highly complex technological problems. For example, as mentioned above, current automated and dietary systems and methods are not customized for individual users. Methods herein solve this technological problem by using automated equipment to track individual food purchases in order to calculate a current diet, and compare the current diet to a recommended diet to make suggested dietary changes that minimize emotional resistance to the change. By granting such benefits to users, the methods herein reduce the amount and complexity of dietary changes, thereby solving a substantial technological problem that users experience today. Also, the systems and methods herein are much more cost effective than a human dietician. Furthermore, the systems and methods herein can monitor the user's progress by tracking future grocery purchases, to see if the suggested diet has been adopted, and continuously adapt the recommendations. Once the user starts to achieve nutrition close to the RDA, the recommendations can automatically cease. Also, the user can specify constraints such as dietary constraints (e.g., the user may be vegan or lactose-intolerant) and budget constraints, and the system can recommend diet changes that satisfy those constraints.

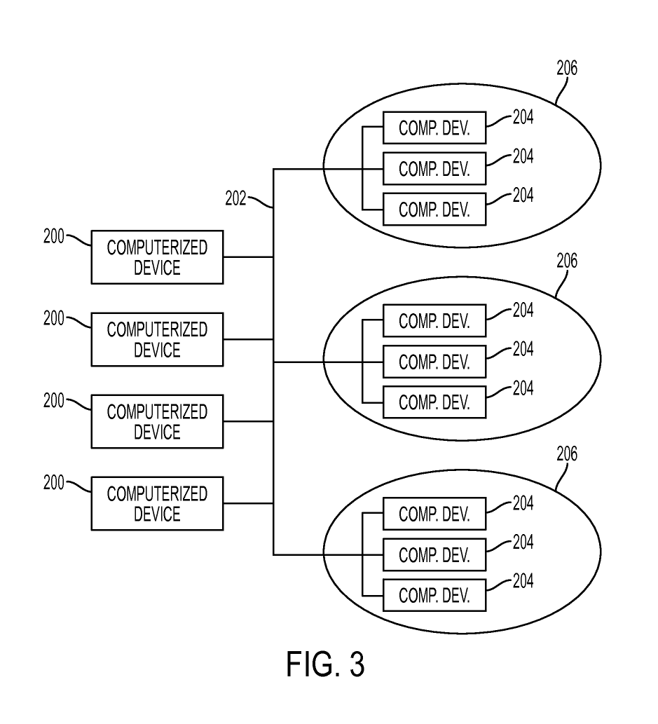

As shown in FIG. 3, exemplary systems and methods herein include various computerized devices 200, 204, located at various different physical locations 206. The computerized devices 200, can include servers, personal computers, etc., and are in communication (operatively connected to one another) by way of a local or wide area (wired or wireless) network 202. Similarly, other computerized devices 204 can include various computerized point-of-sale devices that track users' food purchases, or users' personal computerized devices, such as portable computerized devices, smart phones, laptops, etc.

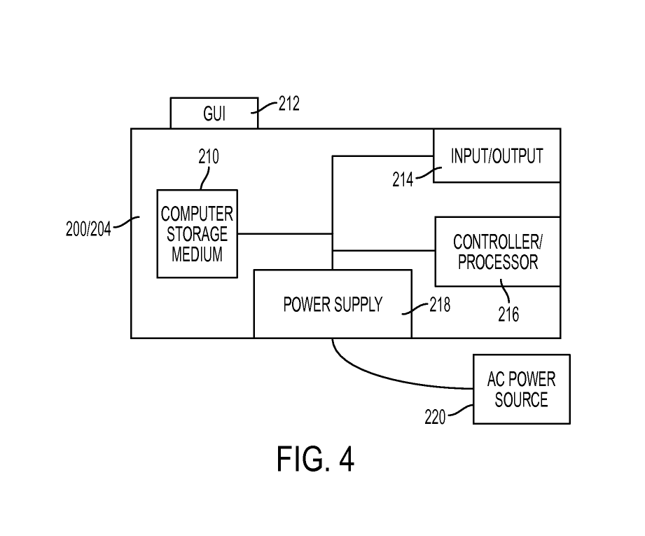

FIG. 4 illustrates an exemplary computerized device 200/204, which can be used with systems and methods herein and can comprise, for example, a server, a personal computer, a portable computing device, a point-of-sale device, etc. The computerized device 200 includes a controller/tangible processor 216 and a communications port (input/output) 214 operatively connected to the tangible processor 216 and to the computerized network 202 external to the computerized device 200. Also, the computerized device 200 can include at least one accessory functional component, such as a graphical user interface (GUI) assembly 212. The user may receive messages, instructions, and menu options from, and enter instructions through, the graphical user interface or control panel 212.

The input/output device 214 is used for communications to and from the computerized device 200 and comprises a wired device or wireless device (of any form, whether currently known or developed in the future). The tangible processor 216 controls the various actions of the computerized device. A non-transitory, tangible, computer storage medium device 210 (which can be optical, magnetic, capacitor based, etc., and is different from a transitory signal) is readable by the tangible processor 216 and stores instructions that the tangible processor 216 executes to allow the computerized device to perform its various functions, such as those described herein. Thus, as shown in FIG. 4, a body housing has one or more functional components that operate on power supplied from an alternating current (AC) source 220 by the power supply 218. The power supply 218 can comprise a common power conversion unit, power storage element (e.g., a battery, etc), etc.

Thus, exemplary systems herein (e.g., FIG. 3) include (among other components) a computerized food purchase history system 204 that automatically determines a current food diet (e.g., based on an automatically maintained food purchase history). For example, the computerized food purchase history system 204 can be a point-of-sale tracking system, an industrial food purchasing system, etc.

A computerized device 200 is operatively connected to the computerized food purchase history system 204 over the computerized network 202. The computerized device 200/204 automatically compares the current food diet with nutritional goals to identify nutritional differences, and analyzes the nutritional differences, to identify potential changes to the current food diet. The process of analyzing the nutritional differences ranks the potential changes based on how the potential changes decrease the nutritional differences and ranks the potential changes based on a previously established measure of emotional resistance to dietary change. Again, the potential changes to the current food diet can include introducing a new food item to the set, removing an existing food item, or increasing or decreasing the current consumption of existing food items, etc.

The computerized device 200/204 then automatically selects one of the potential changes ranked as having the lowest nutritional differences within a calorie limit and an emotional resistance limit as a recommended change to the current food diet. Again, the previously established measure of emotional resistance to dietary change can be based, for example, on historical preferences of a single individual or a group of individuals. The computerized device 200/204 then automatically outputs the recommended change to the current food diet from the computerized device 200/204.

While some exemplary structures are illustrated in the attached drawings, those ordinarily skilled in the art would understand that the drawings are simplified schematic illustrations and that the claims presented below encompass many more features that are not illustrated (or potentially many less) but that are commonly utilized with such devices and systems. Therefore, Applicants do not intend for the claims presented below to be limited by the attached drawings, but instead the attached drawings are merely provided to illustrate a few ways in which the claimed features can be implemented.

Many computerized devices are discussed above. Computerized devices that include chip-based central processing units (CPU's), input/output devices (including graphic user interfaces (GUI), memories, comparators, tangible processors, etc.) are well-known and readily available devices produced by manufacturers such as Dell Computers, Round Rock Tex., USA and Apple Computer Co., Cupertino Calif., USA. Such computerized devices commonly include input/output devices, power supplies, tangible processors, electronic storage memories, wiring, etc., the details of which are omitted herefrom to allow the reader to focus on the salient aspects of the systems and methods described herein. Further, the terms automated or automatically mean that once a process is started (by a machine or a user), one or more machines perform the process without further input from any user.

It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. Unless specifically defined in a specific claim itself, steps or components of the systems and methods herein cannot be implied or imported from any above example as limitations to any particular order, number, position, size, shape, angle, color, or material.

What is claimed is:

1. A method comprising:
automatically determining a current food diet based on an automatically maintained food purchase history using a computerized food purchase history system;
automatically comparing said current food diet with nutritional goals to identify nutritional differences using a computerized device;
automatically analyzing said nutritional differences to identify potential changes to said current food diet using said computerized device, said analyzing said nutritional differences ranking said potential changes based on a previously established measure of emotional resistance to dietary change;
automatically selecting one of said potential changes ranked as having a lowest nutritional differences within a calorie limit and an emotional resistance limit as a recommended change to said current food diet, using said computerized device; and
automatically outputting said recommended change to said current food diet from said computerized device.

2. The method according to claim 1, said previously established measure of emotional resistance to dietary change being based on a magnitude of change and historical preferences of a single individual or a group of individuals.

3. The method according to claim 1, said nutritional differences being based on calories, fat content, cholesterol content, nutrient content, fiber content, and food classes.

4. The method according to claim 1, said potential changes comprising introducing a new food item, removing an existing food item, or increasing or decreasing existing food items.

5. The method according to claim 1, said selecting being additionally based upon user preferences and at least one user health profile.

6. The method according to claim 1, said computerized food purchase history system comprising a point-of-sale tracking system or an industrial food purchasing system.

7. The method according to claim 1, further comprising providing a user option to edit said current food diet.

8. A method comprising:
automatically determining a current food diet based on an automatically maintained food purchase history using a computerized food purchase history system;
automatically transmitting said current food diet from said computerized food purchase history system to a computerized device operatively connected to said food purchase history system;
automatically outputting said current food diet on a graphic user interface of said computerized device;
automatically providing an option to confirm and edit said current food diet on said graphic user interface;
automatically comparing said current food diet with nutritional goals to identify nutritional differences using said computerized device;
automatically analyzing said nutritional differences to identify potential changes to said current food diet using said computerized device, said analyzing said nutritional differences ranking said potential changes based on a previously established measure of emotional resistance to dietary change;
automatically selecting one of said potential changes ranked as having a lowest nutritional differences within a calorie limit and an emotional resistance limit as a recommended change to said current food diet, using said computerized device; and
automatically outputting said recommended change to said current food diet on said graphic user interface of said computerized device.

9. The method according to claim 8, said previously established measure of emotional resistance to dietary change being based on a magnitude of change and historical preferences of a single individual or a group of individuals.

10. The method according to claim 8, said nutritional differences being based on calories, fat content, cholesterol content, nutrient content, fiber content, and food classes.

11. The method according to claim 8, said potential changes comprising introducing a new food item, removing an existing food item, or increasing or decreasing existing food items.

12. The method according to claim 8, said selecting being additionally based upon user preferences and at least one user health profile.

13. The method according to claim 8, said computerized food purchase history system comprising a point-of-sale tracking system or an industrial food purchasing system.

14. The method according to claim 8, further comprising providing a user option to edit said current food diet.

15. A system comprising:
a computerized food purchase history system automatically determining a current food diet based on an automatically maintained food purchase history;
a computerized network operatively connected to said computerized food purchase history system; and
a computerized device operatively connected to said computerized food purchase history system over said computerized network,
said computerized device automatically comparing said current food diet with nutritional goals to identify nutritional differences,
said computerized device automatically analyzing said nutritional differences to identify potential changes to said current food diet, said analyzing said nutritional differences ranking said potential changes based on a previously established measure of emotional resistance to dietary change,
said computerized device automatically selecting one of said potential changes ranked as having a lowest nutritional differences within a calorie limit and an emotional resistance limit as a recommended change to said current food diet based on said ranking, and
said computerized device automatically outputting said recommended change to said current food diet.

16. The system according to claim 15, said previously established measure of emotional resistance to dietary change being based on a magnitude of change and historical preferences of a single individual or a group of individuals.

17. The system according to claim 15, said nutritional differences being based on calories, fat content, cholesterol content, nutrient content, fiber content, and food classes.

18. The system according to claim 15, said potential changes comprising introducing a new food item, removing an existing food item, or increasing or decreasing existing food items.

19. The system according to claim 15, said selecting being additionally based upon user preferences and at least one user health profile.

20. The system according to claim 15, save computerized food purchase history system comprising a point-of-sale tracking system or an industrial food purchasing system.
